(19) United States
(12) Patent Application Publication
(10) Pub. No.: US 2018/0268504 A1
(43) Pub. Date: Sep. 20, 2018

(54) Indexing Mortgage Documents via Blockchains

(71) Applicant: Factom, Austin, TX (US)

(72) Inventors: Mahesh Paolini-Subramanya, Austin, TX (US); Brain Deery, Austin, TX (US); Paul Snow, Austin, TX (US); Jason Nadeau, Missouri City, TX (US)

(21) Appl. No.: 15/459,061

(22) Filed: Mar. 15, 2017

(51) Int. Cl. G06Q 50/16; G06Q 20/38; H04L 9/06; H04L 9/08; G06F 17/30

(52) U.S. Cl. CPC G06Q 50/167; G06Q 20/3829; H04L 9/0643; G06Q 2220/00; H04L 9/0819; G06F 17/30864; H04L 9/0861

(57) ABSTRACT

Indexing of mortgage documents is faster and simpler for auditing purposes. An electronic mortgage application often contains or references a collection of many separate electronic mortgage documents. Indexing data describing the individual electronic mortgage documents and/or the electronic mortgage application may be hashed and integrated into a blockchain. Any auditor receiving the blockchain may thus perform a reverse lookup to generate an index describing the sections and/or pages within the electronic mortgage application. Moreover, the auditor may also verify a current version of the index to an original version created at creation.

### CROSS-REFERENCE TO RELATED APPLICATIONS

This application relates to U.S. application Ser. No. 15/419,033 filed Jan. 30, 2017, to U.S. application Ser. No. 15/419,042 filed Jan. 30, 2017, to U.S. application Ser. No. 15/435,612 filed Feb. 17, 2017, to U.S. application Ser. No. ______ filed ______ [Attorney Document Factom #4], and to U.S. application Ser. No. ______ filed ______ [Attorney Document Factom #5], with all applications incorporated herein by reference in their entireties.

### BACKGROUND

The mortgage industry has learned from the past. The so-called mortgage crisis of 2007 exposed flaws in the mortgage industry. Many mortgages lacked sufficient documentation, checks and balances were not implemented, and fraud was alleged.

### BRIEF DESCRIPTION OF THE SEVERAL VIEWS OF THE DRAWINGS

The features, aspects, and advantages of the exemplary embodiments are understood when the following Detailed Description is read with reference to the accompanying drawings, wherein:

FIGS. 1-5 are simplified illustrations of indexing mortgage documents, according to exemplary embodiments;

FIGS. 6-9 are detailed illustrations of an operating environment, according to exemplary embodiments;

FIG. 10 illustrates index retrieval, according to exemplary embodiments;

FIG. 11 illustrates sequential cryptographic keys, according to exemplary embodiments;

FIG. 12 illustrates sequential assemblage, according to exemplary embodiments;

FIGS. 13-16 further illustrate an index, according to exemplary embodiments;

FIG. 17 illustrates verification of the index, according to exemplary embodiments;

FIG. 18 is a block diagram illustrating a method or algorithm of indexing a mortgage document, according to exemplary embodiments; and

FIGS. 19-20 depict still more operating environments for additional aspects of the exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

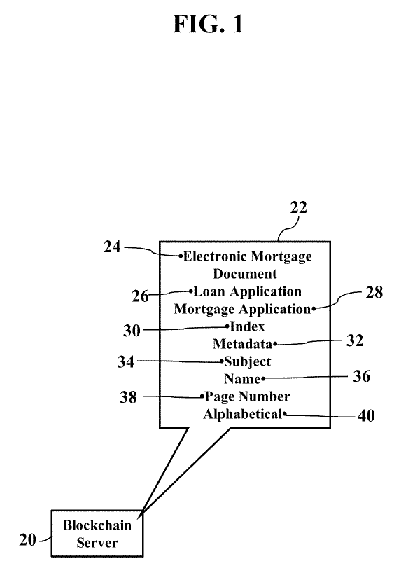

FIGS. 1-5 are simplified illustrations of indexing mortgage documents, according to exemplary embodiments. FIG. 1 illustrates a blockchain server 20 storing electronic data 22 representing one or more electronic mortgage documents 24. The electronic mortgage documents 24 may be a part or a component of loan application 26. Indeed, many readers are likely familiar with an electronic mortgage application 28 that is processed when financing a mortgage for a home or business property. The electronic data 22, however, may be associated with any other type of loan, such as a vehicle installment, business or equipment purchase, and even equity lines of credit.

FIG. 1 also illustrates an index 30. The index 30 is a listing of all the electronic mortgage documents 24 associated with the electronic mortgage application 28. The reader likely understands that the electronic mortgage application 28 contains many different and separate documents. For example, the electronic mortgage application 28 may include an applicant's tax returns, employment verification, pay stubs, bank statements, and other documents. The electronic mortgage application 28 may also contain application paperwork (such as a Uniform Residential Loan Application), purchase agreement, appraisal, title history, and still many more documents. The electronic mortgage application 28 may thus be a collection or an assemblage of the different electronic mortgage documents 24. The index 30 thus provides an informational listing of all the electronic mortgage documents 24 associated with the electronic mortgage application 28. The index 30 may be generated from the electronic data 22 representing the electronic mortgage documents 24. The index 30 may be generated from metadata 32 associated with the electronic mortgage documents 24. The index 30 may be also arranged by topical subject 34, document name 36, and/or page number 38 to promote auditing efforts. The index 30 may additionally or alternatively be alphabetically arranged 40 to aid human search and retrieval.

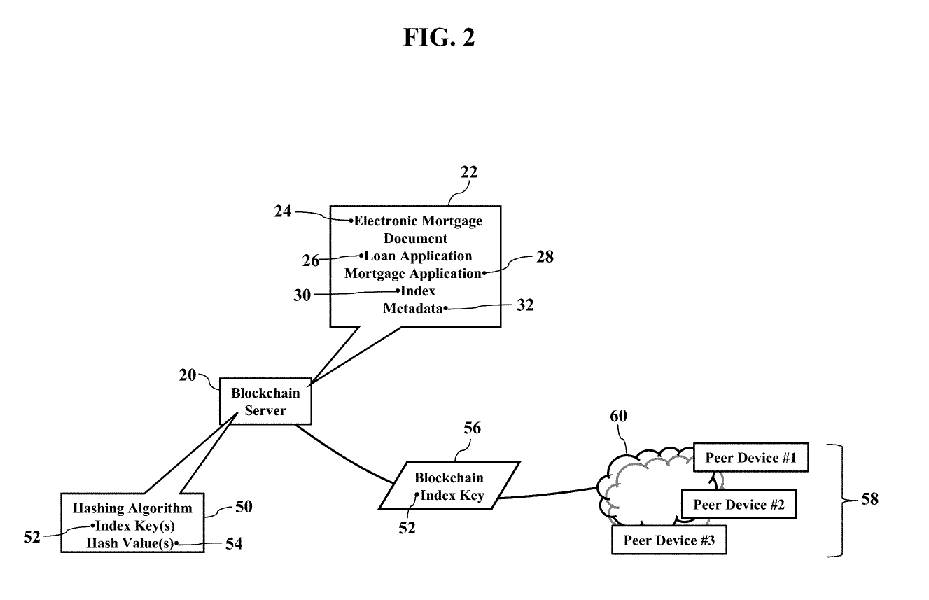

FIG. 2 illustrates secure distribution. Once the electronic mortgage documents 24 are retrieved, their corresponding metadata 32 is used to generate the index 30. Exemplary embodiments may then hash the index 30 using a cryptographic hashing algorithm 50. This disclosure defines the term cryptographic “index key” 52 as the hash value(s) 54 generated from hashing the electronic data 22 associated with the index 30. The index 30 may be hashed to generate a single index key 52 or multiple index keys 52, as later paragraphs will explain. Regardless, the cryptographic index key(s) 52 may then be distributed via one or more blockchains 56 to one or more trusted peer devices 58. That is, the blockchain server 20 may integrate the cryptographic index key(s) 52 into the blockchain(s) 56 and distributed via a communications network 60 to the trusted peer devices 58. Each trusted peer device 58 may thus receive the cryptographic index key(s) 52 incorporated into the blockchain 56.

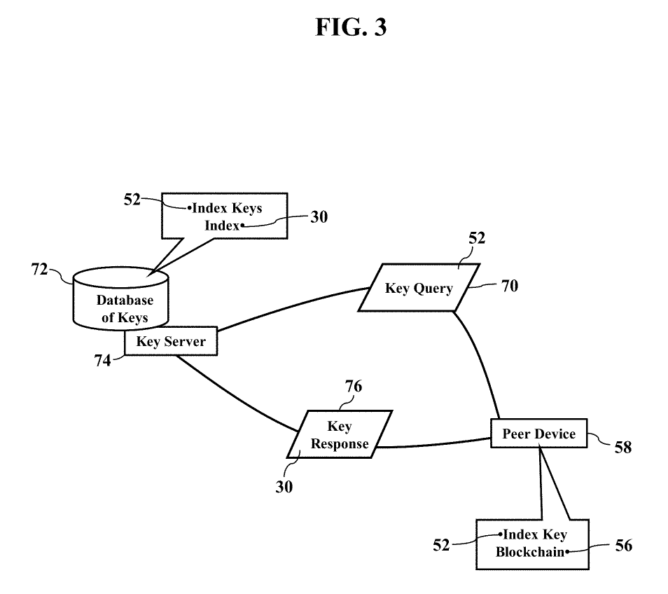

FIG. 3 illustrates indexing discovery. Now that the trusted peer device 58 has the one or more index keys 52 (distributed via the blockchain 56), the trusted peer device 58 may easily and quickly decipher the index key(s) 52. That is, the index key 52 may be used to reverse lookup the index 30. The trusted peer device 58 generates and sends a key query 70 to the network address associated with an electronic database 72 of keys. FIG. 3 illustrates a key server 74 storing or maintaining the electronic database 72 of keys. The electronic database 72 of keys, however, may be stored at maintained at any network device or location (as later paragraphs will explain). The electronic database 72 of keys stores entries that electronically associate different index keys 52 to their corresponding index 30. The trusted peer device 58 queries the key server 74 (via the communications network 60 illustrated in FIG. 2) for the index key 52 received via the blockchain 56. The key server 74 retrieves the corresponding index 30 and sends a key response 76 to the trusted peer device 58. The key response 76 includes information describing the index 30 (such as alphanumeric textual data) retrieved from the electronic database 72 of keys. Exemplary embodiments thus allow the trusted peer device 58 to translate or convert the index key 52 into its corresponding alphanumeric textual data.

Exemplary embodiments thus include elegant auditing tools. Exemplary embodiments cryptographically hash the metadata 32 representing the index 30 to generate the index keys 52 for distribution via the blockchain(s) 56. Any recipient of the blockchain 56 may then simply and quickly convert the index key 52 back into the corresponding textual index 30. If the trusted peer device 58 is operated by or on behalf of an auditing entity, the auditor may quickly and easily use a query operation to determine the index 30 of the electronic mortgage documents 24 associated with the electronic mortgage application 28. The auditor may then easily reference the index 30 when auditing mortgage documents.

Exemplary embodiments may be applied to any electronic document. Most readers are thought familiar with mortgage documents. This disclosure thus mainly explains retrieval of mortgage documents. Exemplary embodiments, though, may be applied to retrieval of any electronic data representing any document.

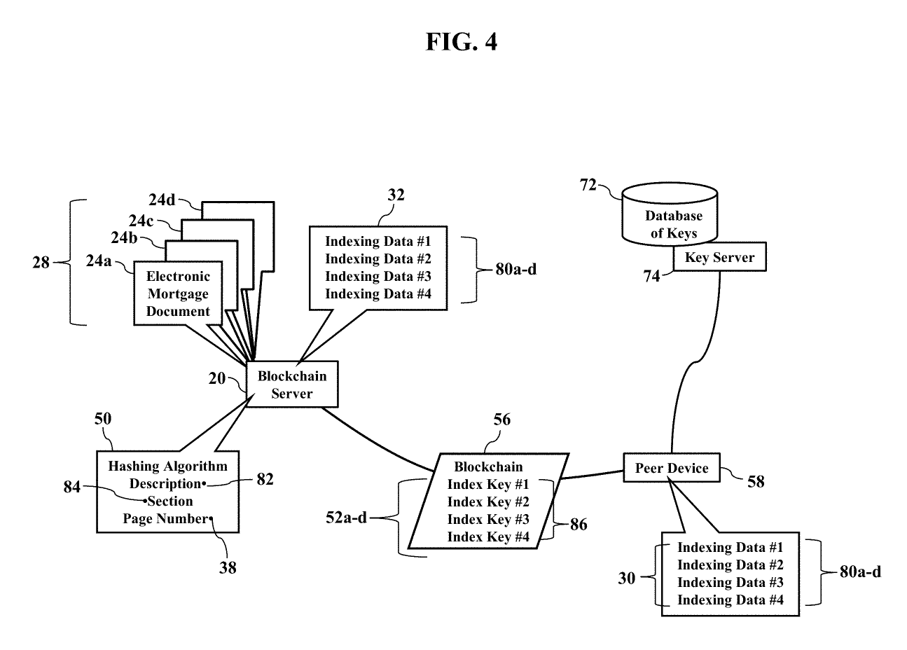

FIG. 4 illustrates multiple index keys 52a-d. Because the electronic mortgage application 28 may contain many separate mortgage documents, here exemplary embodiments may hash indexing data 80a-d associated with each different electronic mortgage document 24a-d. That is, each electronic mortgage document 24 may be associated with the metadata 32 describing its individual indexing data 80. The indexing data 80a-d describes the corresponding electronic mortgage document 24a-d and its individual, informational contribution to the complete electronic mortgage application 28. For example, the indexing data 80 may include a description 82 of corresponding electronic mortgage document 24, perhaps along with a section 84 and/or the page number 38 within the electronic mortgage application 28. Exemplary embodiments may thus hash each individual indexing data 80a-d (using the hashing algorithm 50) associated with each one of the electronic mortgage documents 24a-d within the electronic mortgage application 28, thus generating a series 86 of the index keys 52. The series 86 of the index keys 52 may then be distributed via the blockchain(s) 56 to the trusted peer device 58. The trusted peer device 58 may thus query the electronic database 72 of keys for each index key 52 in the series 86 of the index keys 52a-d and retrieve the corresponding indexing data 80a-d. The trusted peer device 58 may then automatically generate the index 30 associated with the entire electronic mortgage application 28, based on the indexing data 80a-d associated with each corresponding electronic mortgage document 24.

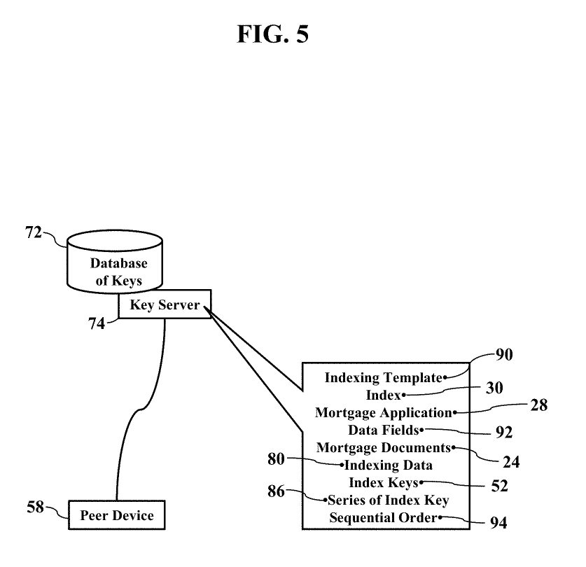

FIG. 5 illustrates an indexing template 90. The indexing template 90 may automatically generate the index 30 associated with the entire electronic mortgage application 28. The indexing template 90 may have multiple data fields 92, with each data field 92 corresponding to one of the electronic mortgage documents 24 within the electronic mortgage application 28. Exemplary embodiments may thus automatically populate the data fields 92 with the indexing data 80 describing the corresponding electronic mortgage document 24. The indexing template 90 may thus include software code or programming that identifies the individual index keys 52 listed in the series 86 of the index keys 52. The indexing template 90 may cause the peer device 58 to query the electronic database 72 of keys for each index key 52 in the series 86 of the index keys 52 and retrieve the corresponding indexing data 80. The indexing template 90 may then automatically populate the corresponding data field 92 with the indexing data 80. The indexing template 90 may thus automatically generate the index 30 describing the entire electronic mortgage application 28 (perhaps based on the individual description 82, section 84, and page number 38 illustrated in FIG. 4). The indexing template 90 generates the overall index 30 that corresponds to a sequential order 94 for each index key 52 in the series 86 of the index keys 52. The indexing template 90 thus describes each electronic mortgage documents 24 with its corresponding description 82, section 84, and/or page number 38.

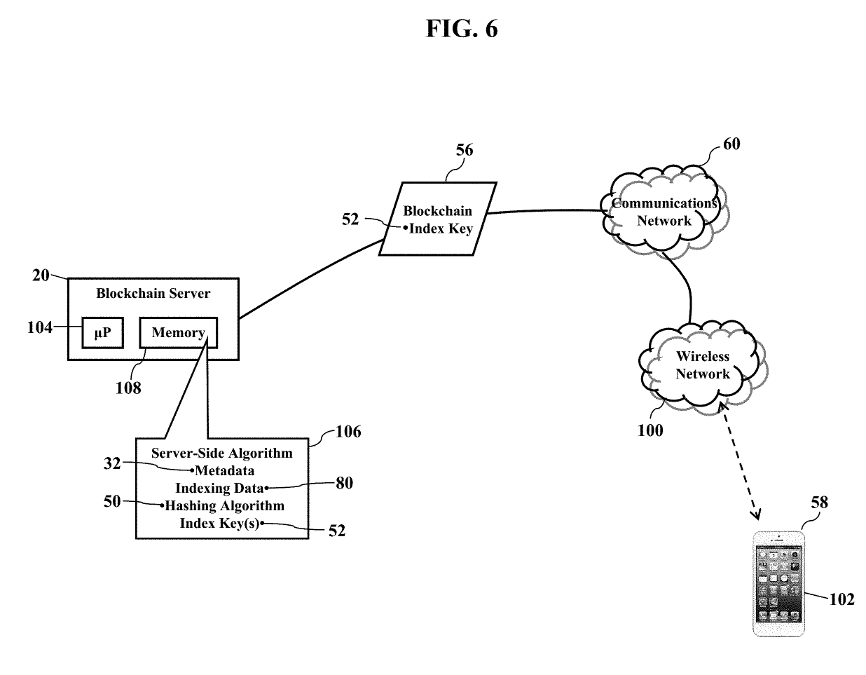

FIGS. 6-9 are detailed illustrations of an operating environment, according to exemplary embodiments. FIG. 6 illustrates the blockchain server 20 communicating with the trusted peer device 58 via the communications network 60 (and perhaps a wireless network 100). FIG. 6 illustrates the trusted peer device 58 as a mobile smartphone 102, which most readers are thought familiar. The trusted peer device 58, though, may be any processor-controlled device, as later paragraphs will explain. The blockchain server 20 may have a processor 104 (e.g., “μP”), application specific integrated circuit (ASIC), or other component that executes a server-side algorithm 106 stored in a local memory device 108. The server-side algorithm 106 includes instructions, code, and/or programs that cause the blockchain server 20 to perform operations, such as hashing the metadata 32 (including the indexing data 80) using the hashing algorithm 50 to generate the one or more index keys 52. The server-side algorithm 106 may then instruct or cause the blockchain server 20 to integrate the cryptographic index key(s) 52 into the blockchain 56 for distribution to the mobile smartphone 102. Exemplary embodiments, though, may send the cryptographic index key 52 and/or the blockchain 56 to any IP address associated with any network destination or device.

Exemplary embodiments may use any hashing function. Many readers may be familiar with the SHA-256 hashing algorithm that generates a 256-bit hash value. Exemplary embodiments obtain or retrieve the metadata 32 representing the indexing data 80. The SHA-256 hashing algorithm acts on the indexing data 80 to generate a 256-bit hash value as the cryptographic index key 52. The index key 52 is thus a digital signature that uniquely represents the indexing data 80. There are many hashing algorithms, though, and exemplary embodiments may be adapted to any hashing algorithm.

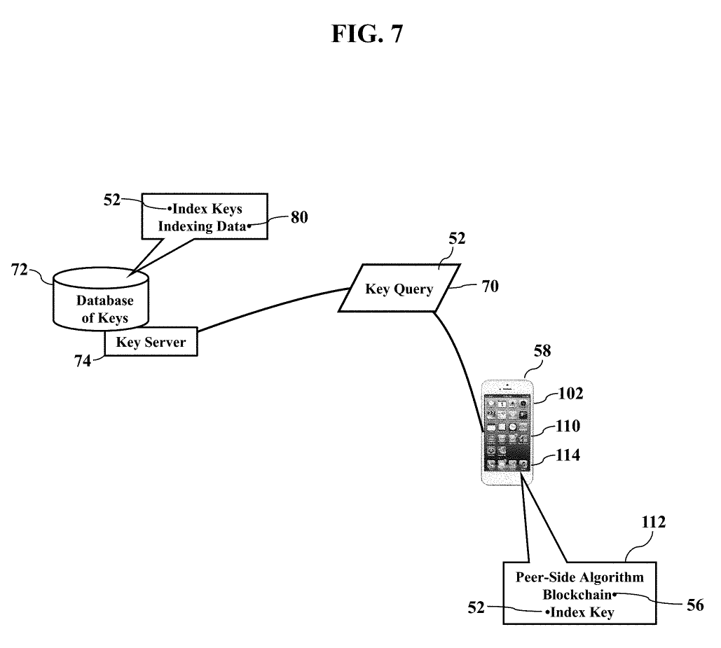

FIG. 7 illustrates key conversion. Now that the blockchain 56 is distributed, the trusted peer device 58 (again illustrated as the mobile smartphone 102) may reverse convert the index key 52 into the corresponding indexing data 80. The mobile smartphone 102 has a processor 110, application specific integrated circuit (ASIC), or other component that executes a peer-side algorithm 112 stored in a local memory device 114. The peer-side algorithm 112 includes instructions, code, and/or programs that cause the processor 90 to perform operations, such as generating and sending the key query 70 to the network address (e.g., Internet Protocol address) associated with the key server 74 storing or maintaining the electronic database 72 of keys.

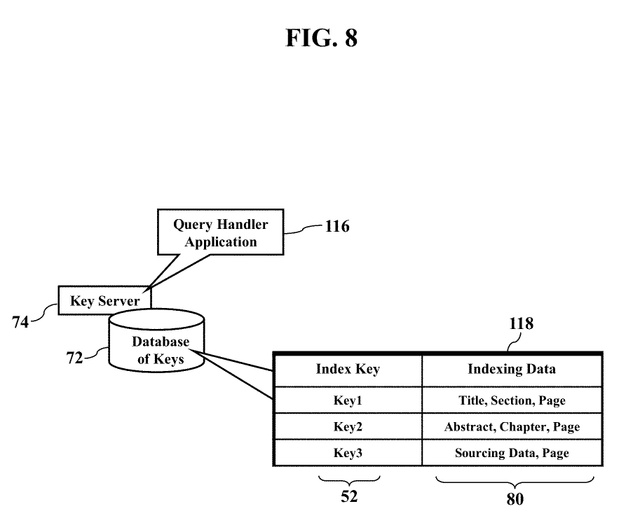

FIG. 8 further illustrates the electronic database 72 of keys. The key server 74 functions to answer queries submitted by authorized clients. That is, the key server 74 executes a query handler application 116 that accepts the index key 52 as a query term. The query handler application 116 may then search the electronic database 72 of keys for a matching entry. While the electronic database 72 of keys may have any structure, FIG. 8 illustrates the electronic database 72 of keys as a table 118 that electronically maps, relates, or associates different index keys 52 to their corresponding indexing data 80. The electronic database 72 of keys may thus be loaded or configured with data or information describing mortgage documents. If a match is determined, the corresponding index key 52 is identified. FIG. 8 illustrates the electronic database 72 of keys as being locally stored in the key server 72, but some of the database entries may be dispersed to multiple other devices or locations in the communications network (illustrated as reference numeral 60 in FIGS. 2 and 6). While FIG. 8 only illustrates a few entries, in practice the electronic database 72 of keys may contain hundreds, thousands, or even millions of entries detailing many mortgage documents.

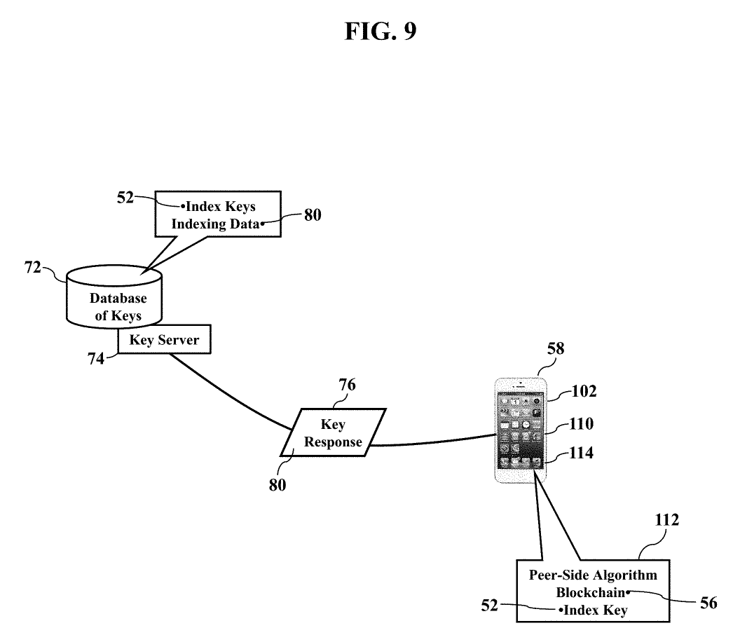

FIG. 9 illustrates database replies. The trusted peer device 58 queries the electronic database 72 of keys for the index key 52 received via the blockchain 56. The key server 72 retrieves and packages the corresponding indexing data 80 as the key response 76. The key server 72 sends the key response 76 to the network address (e.g., IP address) associated with the trusted peer device 58 (such as the mobile smartphone 102).

Exemplary embodiments may be applied regardless of networking environment. Exemplary embodiments may be easily adapted to stationary or mobile devices having cellular, wireless fidelity (WI-FI®), near field, and/or BLUETOOTH® capability. Exemplary embodiments may be applied to mobile devices utilizing any portion of the electromagnetic spectrum and any signaling standard (such as the IEEE 802 family of standards, GSM/CDMA/TDMA or any cellular standard, and/or the ISM band). Exemplary embodiments, however, may be applied to any processor-controlled device operating in the radio-frequency domain and/or the Internet Protocol (IP) domain. Exemplary embodiments may be applied to any processor-controlled device utilizing a distributed computing network, such as the Internet (sometimes alternatively known as the “World Wide Web”), an intranet, a local-area network (LAN), and/or a wide-area network (WAN). Exemplary embodiments may be applied to any processor-controlled device utilizing power line technologies, in which signals are communicated via electrical wiring. Indeed, exemplary embodiments may be applied regardless of physical componentry, physical configuration, or communications standard(s).

Exemplary embodiments may utilize any processing component, configuration, or system. Any processor could be multiple processors, which could include distributed processors or parallel processors in a single machine or multiple machines. The processor can be used in supporting a virtual processing environment. The processor could include a state machine, application specific integrated circuit (ASIC), programmable gate array (PGA) including a Field PGA, or state machine. When any of the processors execute instructions to perform operations, this could include the processor performing the operations directly and/or facilitating, directing, or cooperating with another device or component to perform the operations.

Exemplary embodiments may packetize. The blockchain server 20 and the trusted peer device 58 may have network interfaces to the communications network 60, thus allowing collection and retrieval of information. The information may be received as packets of data according to a packet protocol (such as the Internet Protocol). The packets of data contain bits or bytes of data describing the contents, or payload, of a message. A header of each packet of data may contain routing information identifying an origination address and/or a destination address associated with any of the blockchain server 20 and the trusted peer device 58.

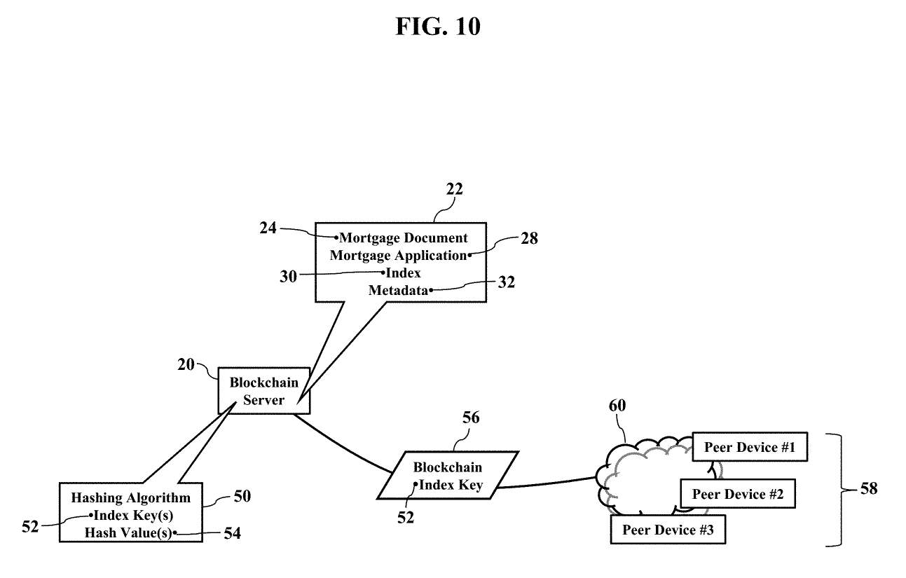

FIG. 10 illustrates index retrieval, according to exemplary embodiments. Here the index 30 describes all the electronic mortgage documents 24 making up the entire electronic mortgage application 28. The index 30 may be based on the metadata 32, and the index 30 may be as simple or richly detailed as needed, depending on complexity or completeness. The index 30 and/or the metadata 32 may be populated by an originator or creator of the particular electronic mortgage document 24. The index 30 and/or the metadata 32 may also be populated by an owner of the electronic mortgage application 28 (such as lender or contractor). The data representing the index 30 is hashed (using the cryptographic hashing algorithm 50) to generate the index key(s) 52. The cryptographic index key(s) 52 is/are distributed via the blockchain(s) 46 to the trusted peer device 58. When the trusted peer device 58 receives the blockchain 56, the trusted peer device 58 may then query the electronic database 72 of keys to retrieve the corresponding alphanumeric data describing the index 30. The peer-side algorithm 112 may thus process the index 30 for display and for use.

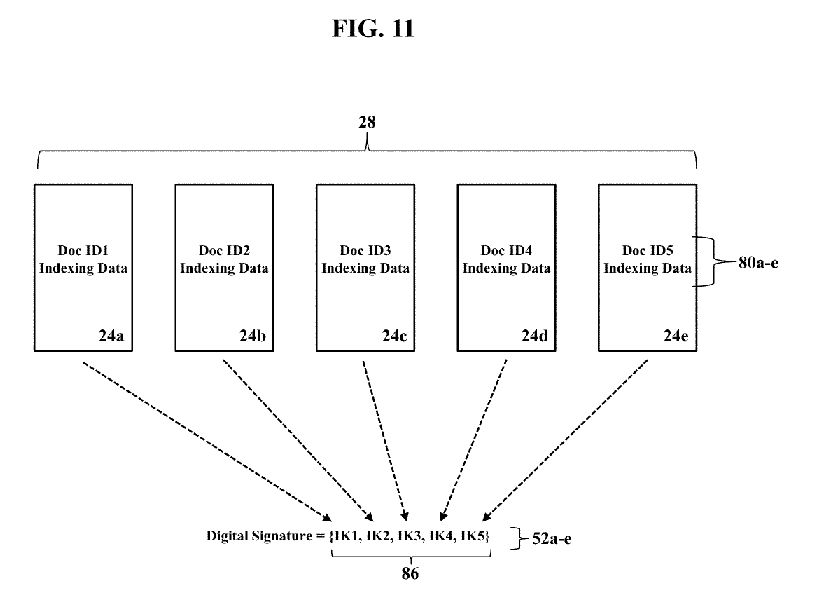

FIG. 11 illustrates sequential cryptographic keys, according to exemplary embodiments. Here exemplary embodiments may generate the series 86 of the index keys (“IK”) 52 representing the individual indexing data 80 describing each electronic mortgage document 24 within the completed electronic mortgage application 28. Again, even though the electronic mortgage application 28 may have many pages of individual, different mortgage documents, for simplicity FIG. 11 only illustrates five (5) different electronic mortgage documents 24a-e. Each electronic mortgage document 24a-e is associated with its corresponding indexing data 80a-e. Exemplary embodiments may hash each document's indexing data 80a-e to generate the corresponding index key 52a-e. Exemplary embodiments may then assemble or package the multiple index keys 52a-e as the series 86 ({SK1, SK2, SK3, SK4, SK5}). The series 86 may then be distributed via the blockchain 56 (as this disclosure above explains). The trusted peer device 58 may then query the database 72 of keys to determine the corresponding indexing data 80a-e (explained with reference to FIGS. 7-9). The trusted peer device 58 may then use the indexing data 80a-e to generate the index 30 (explained with reference to FIGS. 1, 5, and 10).

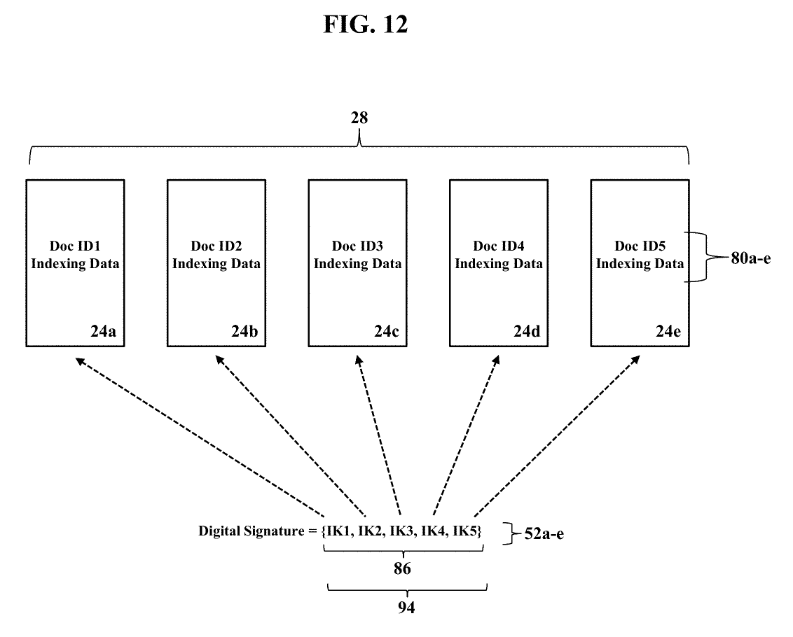

FIG. 12 illustrates sequential assemblage, according to exemplary embodiments. Here exemplary embodiments may assemble the individual pieces or strings of the indexing data 80a-e according to the series 86 specified by the blockchain 56. If the series 86 specifies the sequential order 94 of the index keys 52a-e, then exemplary embodiments may retrieve and assemble the electronic mortgage documents 24a-e in the same sequential order 94. The sequential order of the index keys 52a-e, in plain words, may thus also correspond to the sequential order 94 described by the index 30. Exemplary embodiments may thus arrange the indexing data 80a-e according to the series 86 of the index keys 52 specified by the blockchain 56. The overall index 30 (describing the electronic mortgage application 28) may thus be constructed according to the sequential order 94 of the index keys 52.

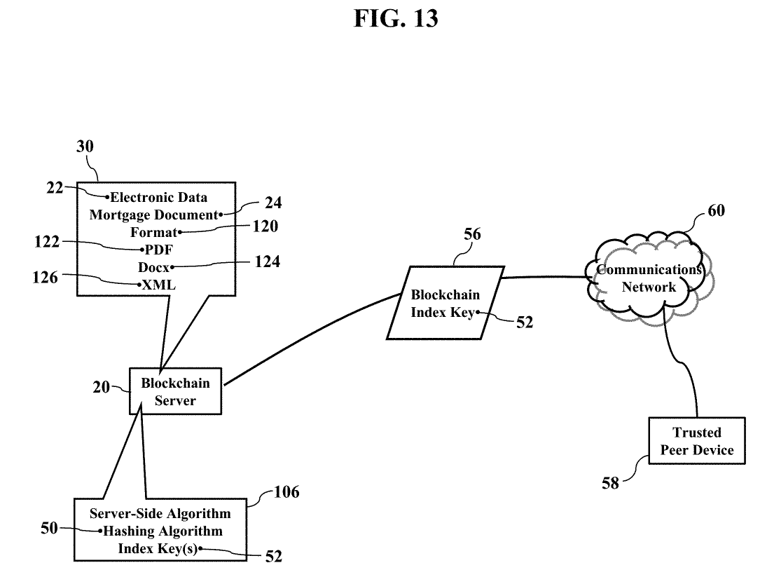

FIGS. 13-16 further illustrate the index 30, according to exemplary embodiments. Here the index 30 may include the electronic data 22 representing the electronic mortgage document 24. For example, the electronic data 22 is typically formatted according to one or more formats 120. Most readers, for example, are thought familiar with a portable document format (“PDF”) 122, the MICROSOFT® WORD® extensible markup language extension (“docx”) 124, and/or the extensible markup language (“XML”) 126. Exemplary embodiments may thus retrieve the electronic data 22 representing the electronic mortgage document 24 and/or the index 30 and generate the corresponding index key 52 (such as the corresponding 256-bit hash if using the SHA-256 hashing algorithm 50). Exemplary embodiments may then incorporate the index key 52 into the blockchain 56 for distribution via the communications network 60. Any destination (such as the trusted peer device 58) may thus audit the electronic mortgage document 24 and/or the index 30 against the blockchain 56 (as this disclosure above explains).

Exemplary embodiments may be applied to any file formatting and/or specification. The format 120 may be proprietary, free, unpublished, and/or open. The format 120 may be designed for images, containers, audio, video, text, subtitles, control characters, and encoding schemes. The format 120 may be HTML, vector graphics, source code, text files, syntax, and software programming.

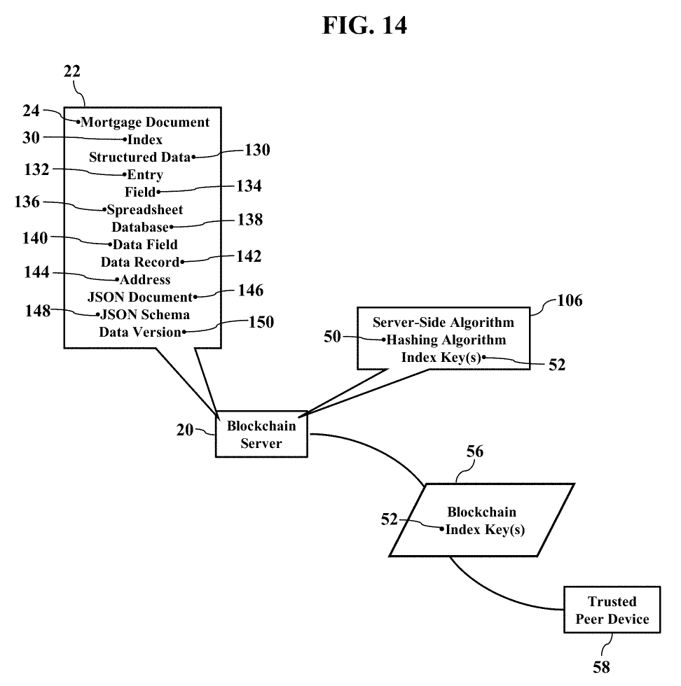

FIG. 14 illustrates structured data 130. As the reader may understand, the electronic data 22 representing the electronic mortgage document 24 and/or the index 30 may be the structured data 130. That is, the structured data 130 may be organized (such as an entry 132 or database field 134 in a relational spreadsheet 136 or database 138), contained within a fixed data field 140 or data record 142, and/or be addressable via a network or memory address 144. Again referencing the electronic mortgage application 28, the structured data 130 may be organized according to the JavaScript Object Notation (or “JSON”). As the JavaScript Object Notation is a known format for structuring data, the JSON format need not be explained in detail. Suffice it to say that at least some of the electronic data 22 representing the electronic mortgage document 24 and/or the index 30 may be a JSON document 146 having the structured data 130 arranged as fields, formatted according to a JSON schema 148.

Exemplary embodiment may thus incorporate a data version 150 in the index 30. For example, if the electronic mortgage document 24 and/or the index 30 is the JSON document 146, then the data version 150 may be the structured data 130 arranged or formatted according to the JSON schema 148. Exemplary embodiments may thus retrieve the data version 150 and generate the corresponding index key 52 (such as the 256-bit hash value using the SHA-256 hashing algorithm 50). Exemplary embodiments may then incorporate the index key 52 into the blockchain 56 for distribution (such as to the trusted peer device 58). The trusted peer device 58 may thus audit the index 30 against the blockchain 56 (as this disclosure above explains). Moreover, once the structured data 130 is known (such as JSON schema 148), any mortgage document 24 referenced in the index 30 may be recreated, hashed, and checked against the blockchain 56 to ensure the electronic data 22 has not been altered. For example, if the electronic data 22 representing the electronic mortgage document 24 is stored in a banking server, then exemplary embodiments permit recreating the mortgage document 24 (perhaps via a POSGRES® database) and authentication.

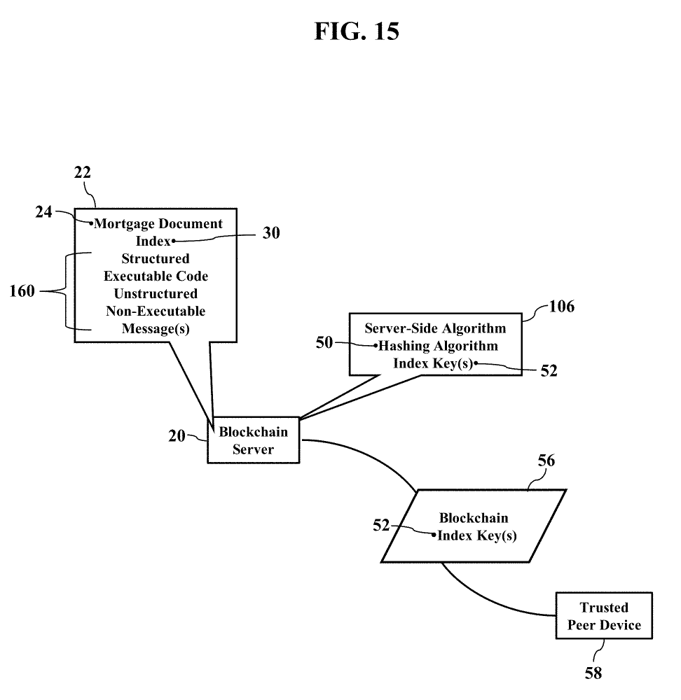

FIG. 15 illustrates instructions 160. Here the electronic data 22 representing the index 30 may include the instructions 160. While exemplary embodiments may be applicable to any instructions, the instructions 160 may be structured (such as executable code), unstructured instructions (such as non-executable commentary lines in code, such as English language “do thing 1, then thing 2, then thing 3”). Other instructions 160 may include any messages (such as “When this document is accessed, POST to the URL http://some.target.url”). Exemplary embodiments may thus retrieve the instructions 160, generate the corresponding index key 52 (such as the 256-bit hash value representing the instructions 160), and incorporate into the blockchain 56. Again, if the index key 52 representing the instructions 160 has changed over time, then exemplary embodiments may flag or notify of a possible fraud attempt.

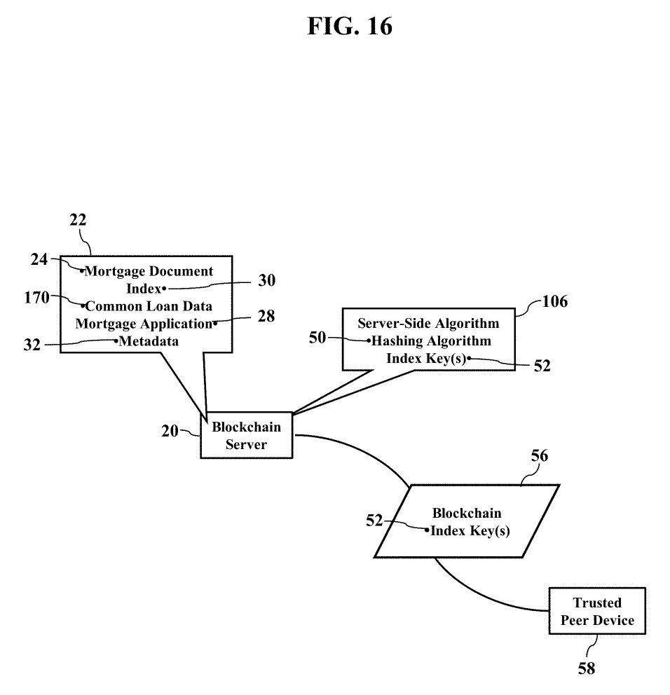

FIG. 16 illustrates common loan data 170. Here the index 30 may include data or information that is common or applicable to each electronic mortgage document 24 within the entire electronic mortgage application 28. For example, each electronic mortgage document 24 may be associated with the metadata 32 describing the mortgage applicant's name and a property address (e.g., street, city, state, ZIP). Because the individual electronic mortgage documents 24 likely relate to the same applicant's name and a property address, this metadata 32 may be common to all pages and/or documents within the electronic mortgage application 28. Similarly, the common loan data 170 may also include or describe a property tax identification (or “property tax ID”) associated with the property address. The common loan data 170 may also include or describe a financial lender (such as WELLS FARGO® or BANK OF AMERICA®) offering, evaluating, and/or processing the electronic mortgage application 28. Whatever the common loan data 170 describes, exemplary embodiments may incorporate the common loan data 170 into the index 30, hash using the hashing algorithm 50, and distribute via the blockchain 56.

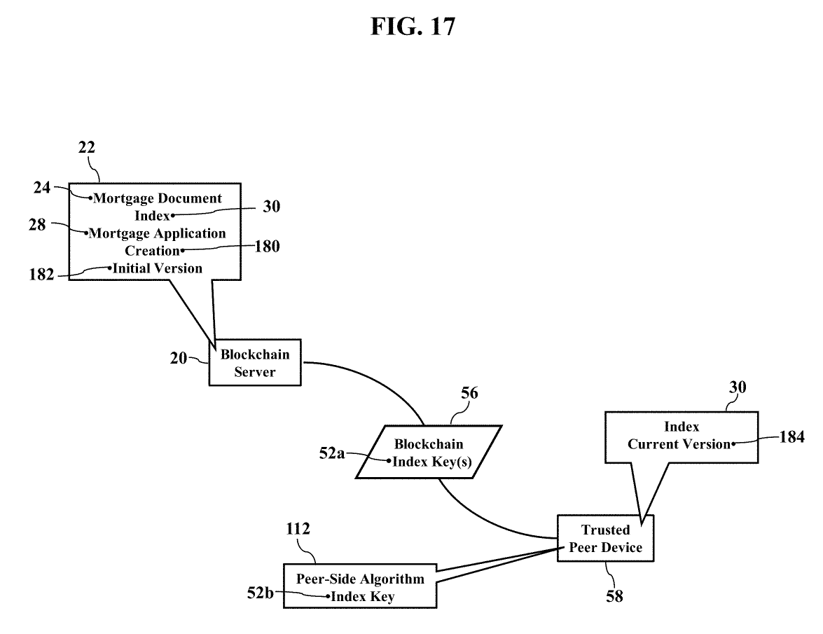

FIG. 17 illustrates verification of the index 30, according to exemplary embodiments. Here exemplary embodiments may determine whether the electronic mortgage application 28 has changed since a date/time of creation 180, based on the index 30. That is, when the electronic mortgage application 28 is initially created and/or saved, an initial version 182 of the index 30 may be generated and hashed to produce the index key(s) 52a (perhaps for distribution via the blockchain 56, as this disclosure previously explained). Whenever an auditor (such as the trusted peer device 58) retrieves a current version 184 of the index 30 and computes its corresponding index key 52b, the auditor may check for a match. The trusted peer device 58, for example, may generate verification hash values based on hashing the current version 184 of the index 30. If the verification hash values match the index key 52a previously received via the blockchain 56, then the trusted peer device 58 may infer that the index 30 is authentic. That is, perhaps the electronic mortgage application 24 has not changed since the date and time of the creation 180 and further auditing efforts are unnecessary. However, if the verification hash values fail to match the index key 52a previously received via the blockchain 56, then the electronic mortgage application 24 may be inauthentic. The electronic data 22 representing the current version 184 of the index 30, in other words, has changed and/or been altered since the creation 180. The trusted peer device 58 may thus generate a fraud alert to implement enhanced security measures.

Exemplary embodiments thus include third party validation. At any time, the trusted peer device 58 may verify the authenticity of the electronic data 22 representing the index 30. If hashing of the current version 184 of the index 30 yields a different result from the blockchain 56, then the electronic mortgage application 24 has been unintentionally, intentionally, or even maliciously altered since the creation 180. This disclosure need not speculate on why the index 30 was changed. Suffice it to say that the trusted peer device 58 may merely generate a fraud alert to escalate further investigation. The trusted peer device 58 may thus be operated on behalf of a third-party vendor, supplier, sub-contractor, or even a governmental entity. Exemplary embodiments, in plain words, permit simple and quick oversight of mortgage documentation.

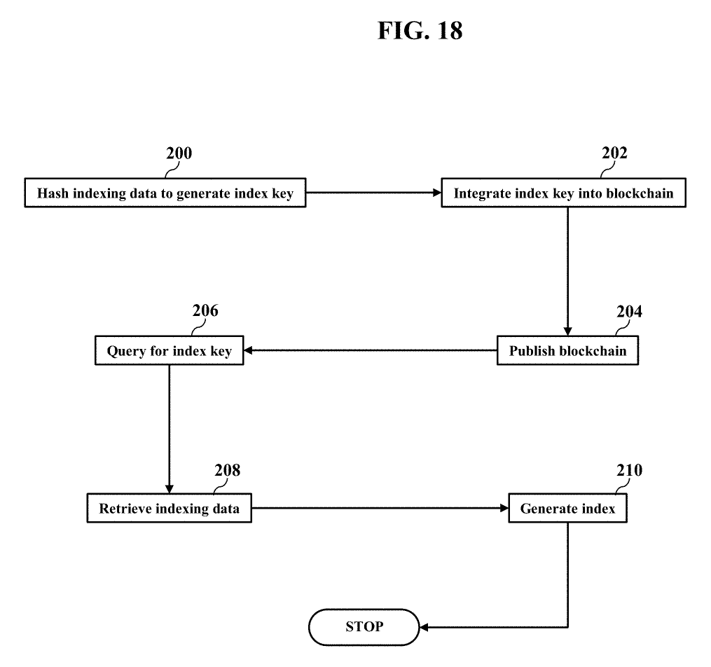

FIG. 18 is a block diagram illustrating a method or algorithm of indexing a mortgage document, according to exemplary embodiments. The indexing data 80 is hashed to generate the index key 52 (Block 200). The index key 52 is integrated into the blockchain 56 (Block 202) and published for distribution (Block 204). Any recipient of the blockchain 56 may thus query the electronic database 72 of keys (Block 206) and retrieve the corresponding indexing data 80 (Block 208). The indexing data 80 may thus be used to generate the index 30 describing the collection of the mortgage documents 24 associated with the electronic mortgage application 28 (Block 210).

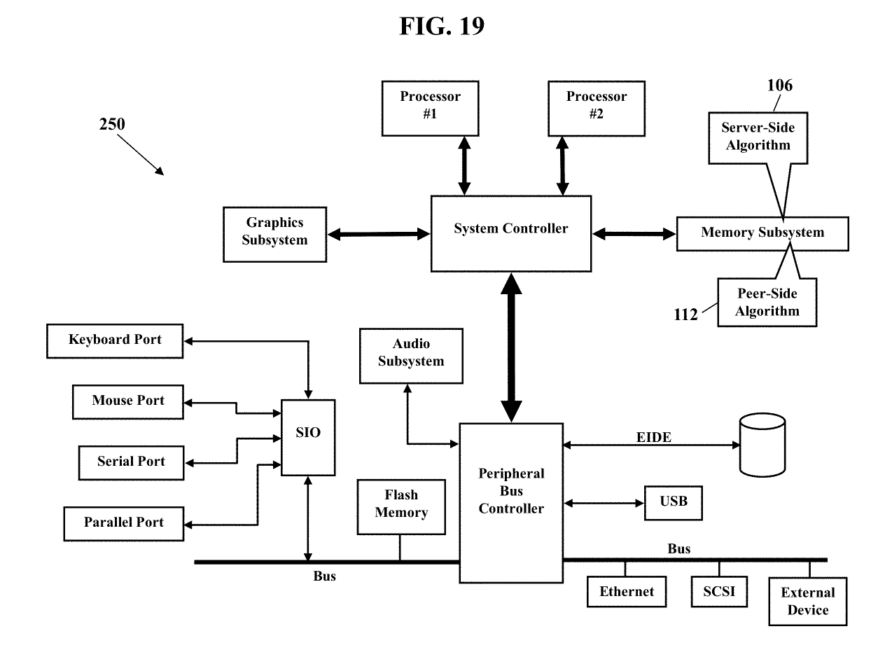

FIG. 19 is a schematic illustrating still more exemplary embodiments. FIG. 19 is a more detailed diagram illustrating a processor-controlled device 250. As earlier paragraphs explained, the server-side algorithm 106 and the peer-side algorithm 112 may partially or entirely operate in any mobile or stationary processor-controlled device. FIG. 19, then, illustrates the server-side algorithm 106 and the peer-side algorithm 112 stored in a memory subsystem of the processor-controlled device 250. One or more processors communicate with the memory subsystem and execute either, some, or all applications. Because the processor-controlled device 250 is well known to those of ordinary skill in the art, no further explanation is needed.

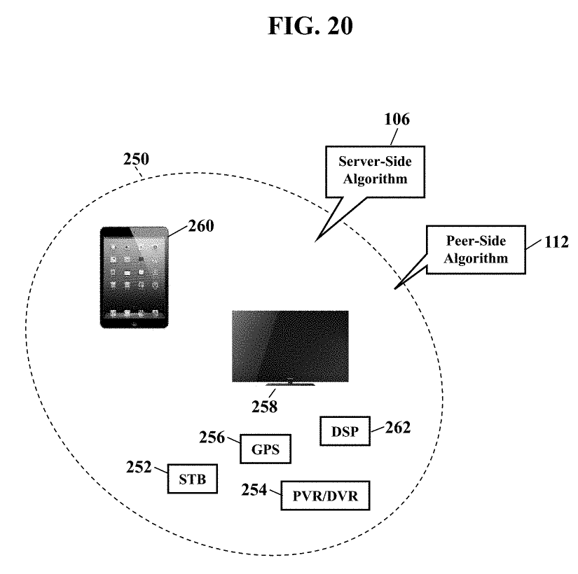

FIG. 20 depicts other possible operating environments for additional aspects of the exemplary embodiments. FIG. 20 illustrates the server-side algorithm 106 and the peer-side algorithm 112 operating within various other processor-controlled devices 250. FIG. 20, for example, illustrates that the server-side algorithm 106 and the peer-side algorithm 112 may entirely or partially operate within a set-top box (“STB”) (252), a personal/digital video recorder (PVR/DVR) 254, a Global Positioning System (GPS) device 256, an interactive television 258, a tablet computer 260, or any computer system, communications device, or processor-controlled device utilizing any of the processors above described and/or a digital signal processor (DP/DSP) 262. Moreover, the processor-controlled device 250 may also include wearable devices (such as watches), radios, vehicle electronics, clocks, printers, gateways, mobile/implantable medical devices, and other apparatuses and systems. Because the architecture and operating principles of the various devices 250 are well known, the hardware and software componentry of the various devices 250 are not further shown and described.

Exemplary embodiments may be applied to any signaling standard. Most readers are thought familiar with the Global System for Mobile (GSM) communications signaling standard. Those of ordinary skill in the art, however, also recognize that exemplary embodiments are equally applicable to any communications device utilizing the Time Division Multiple Access signaling standard, the Code Division Multiple Access signaling standard, the “dual-mode” GSM-ANSI Interoperability Team (GAIT) signaling standard, or any variant of the GSM/CDMA/TDMA signaling standard. Exemplary embodiments may also be applied to other standards, such as the I.E.E.E. 802 family of standards, the Industrial, Scientific, and Medical band of the electromagnetic spectrum, BLUETOOTH®, and any other.

Exemplary embodiments may be physically embodied on or in a computer-readable storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for indexing mortgage documents, as the above paragraphs explained.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

1. A method of indexing an electronic mortgage application, the method comprising:
receiving, by a hardware processor, a blockchain having a cryptographic index key integrated therein;
querying, by the hardware processor, an electronic database for the cryptographic index key integrated in the blockchain, the electronic database electronically associating indexing data to cryptographic index keys including the cryptographic index key integrated in the blockchain;
identifying, by the hardware processor, the indexing data in the electronic database that is electronically associated with the cryptographic index key integrated in the blockchain; and
generating, by the hardware processor, an electronic index based on the indexing data identified in the electronic database that is electronically associated with the cryptographic index key integrated in the blockchain, the electronic index describing a collection of mortgage documents associated with the electronic mortgage application.

2. The method of claim 1, further comprising generating a query specifying the cryptographic index key integrated in the blockchain.

3. The method of claim 2, further comprising sending the query via a communications network to a server hosting the electronic database.

4. The method of claim 1, further comprising retrieving the indexing data.

5. The method of claim 1, further comprising retrieving a template for the generating of the electronic index.

6. The method of claim 5, further comprising populating a data field associated with the template with the indexing data identified in the electronic database that is electronically associated with the cryptographic index key integrated in the blockchain.

7. The method of claim 5, further comprising populating a data field associated with the template with the cryptographic index key integrated in the blockchain.

8. A system, comprising:
a hardware processor; and
a memory device, the memory device storing instructions, the instructions when executed causing the hardware processor to perform operations, the operations comprising:
retrieving metadata associated with an electronic mortgage application, the metadata describing an index of mortgage documents associated with the electronic mortgage application;
generating a cryptographic index key in response to hashing the metadata describing the index using an electronic representation of a hash function; and
distributing the cryptographic index key via a blockchain;
wherein the blockchain distributes the cryptographic index key that is based on the metadata describing the index of the mortgage documents associated with the electronic mortgage application.

9. The system of claim 8, wherein the operations further comprise integrating the cryptographic index key into the blockchain.

10. The system of claim 8, wherein the operations further comprise receiving a query specifying the cryptographic index key.

11. The system of claim 8, wherein the operations further comprise querying an electronic database for the cryptographic index key specified by the query, the electronic database electronically associating indexing data to cryptographic index keys including the cryptographic index key specified by the query.

12. The system of claim 11, wherein the operations further comprise retrieving the indexing data from the electronic database that is electronically associated to the cryptographic index key specified by the query.

13. The system of claim 8, wherein the operations further comprise integrating the cryptographic index key in the blockchain.

14. The system of claim 8, wherein the operations further comprise populating a template with the cryptographic index key integrated in the blockchain.

15. A memory device storing instructions that when executed cause a hardware processor to perform operations, the operations comprising:
receiving a blockchain having a series of cryptographic index keys integrated therein, the cryptographic index keys generated from hashing metadata associated with an electronic mortgage application;
querying an electronic database for each one of the cryptographic index keys integrated in the blockchain, the electronic database electronically associating indexing data to the cryptographic index keys;
identifying the indexing data in the electronic database that is electronically associated with the cryptographic index keys integrated in the blockchain; and
generating an electronic index based on the indexing data identified in the electronic database that is electronically associated with the cryptographic index keys integrated in the blockchain, the electronic index describing a collection of mortgage documents associated with the electronic mortgage application.

16. The memory device of claim 15, wherein the operations further comprise retrieving the indexing data.

17. The memory device of claim 15, wherein the operations further comprise retrieving a template for the generating of the electronic index.

18. The memory device of claim 17, wherein the operations further comprise populating a data field associated with the template with the indexing data identified in the electronic database that is electronically associated with the cryptographic index keys integrated in the blockchain.

19. The memory device of claim 17, wherein the operations further comprise populating data fields associated with the template with the cryptographic index keys integrated in the blockchain.

20. The memory device of claim 15, wherein the operations further comprise generating a query specifying the cryptographic index keys integrated in the blockchain.
